(19) United States
(12) Patent Application Publication
(10) Pub. No.: US 2013/0282956 A1
(43) Pub. Date: Oct. 24, 2013

(54) Automobile MP3 System

(71) Applicant: Pradeep Ramdeo, Bronx, NY (US)

(72) Inventor: Pradeep Ramdeo, Bronx, NY (US)

(21) Appl. No.: 13/451,597

(22) Filed: Apr. 20, 2012

(51) Int. Cl. G06F 12/02

(52) U.S. Cl. 711/103; 711/E12.008

(57) ABSTRACT

An automobile MP3 system for an automobile is provided. The automobile MP3 system comprises a data storage device mounted within the automobile, the data storage device having memory for holding content and content downloading capability. The data storage device stores music and other content.

### BACKGROUND OF THE INVENTION

1. Field of the Invention

This invention relates generally to an automobile MP3 and more particularly, the invention relates to an automobile MP3 player featuring extensive memory as well as downloading capability.

2. Description of the Prior Art

Over the course of the century just past, America became a nation of automobiles and highways. From our perspective today in a predominantly urban, automobile-based society, it is hard to imagine an American landscape not laced with superhighways and everything that goes with them, from the convenience of superstores to the frustrations of traffic.

The earliest cars lacked radios. However, by the mid-1920s, bulky, supposedly portable “travel radios” requiring two large, exterior batteries for their operation had made their appearance. While these early units were a good idea, the radios required different voltages than could be supplied by the car battery; reception was notoriously poor; a variety of antennae were tried and found lacking; and the radio itself, with its array of vacuum-tubes, was far too large and fragile to travel well. The travel radio, in fact, could only be operated when the car's engine was off. Even so, interference from the metal engine was constant; tuning the radio receiver was difficult; and even when tuned, the loudspeakers were so weak that one could hardly hear.

Over time, engineers solved these and other problems, and by the mid-1930s, most of the early drawbacks had been addressed. By the late 1950s, with the replacement of vacuum tubes by transistors, car radio along with the last great decade of AM radio had finally arrived. The late-1960s and early 70s brought the 8-track tape and the cassette followed soon thereafter. Now a motorist could choose his or her traveling music at will. Cassette tapes yielded to compact discs and compact discs to MP-3s. Today, a growing variety of “downloadable” technologies and personal listening devices allow the consumer to take an almost unlimited quantity and variety of music, even movies and music videos, off the Internet or off a programmed multi-station satellite transmitter. But while these technologies have freed the listener from the bondage of having to listen to whatever's playing on the radio, our wider range of choice comes at a price. Car stereos may well be capable of playing a CD, but not storing a downloaded song library.

### SUMMARY

The present invention is an automobile MP3 system for an automobile. The automobile MP3 system comprises a data storage device mounted within the automobile, the data storage device having memory for holding content and content downloading capability. The data storage device stores music and other content.

### BRIEF DESCRIPTION OF THE DRAWINGS

FIG. 1 is a perspective view illustrating the automobile MP3 system, constructed in accordance with the present invention;

FIG. 2 is a perspective view illustrating the memory card slots and USB port of the automobile MP3 system, constructed in accordance with the present invention; and

FIG. 3 is another perspective view illustrating the automobile MP3 system, constructed in accordance with the present invention.

### DETAILED DESCRIPTION OF THE PREFERRED EMBODIMENTS

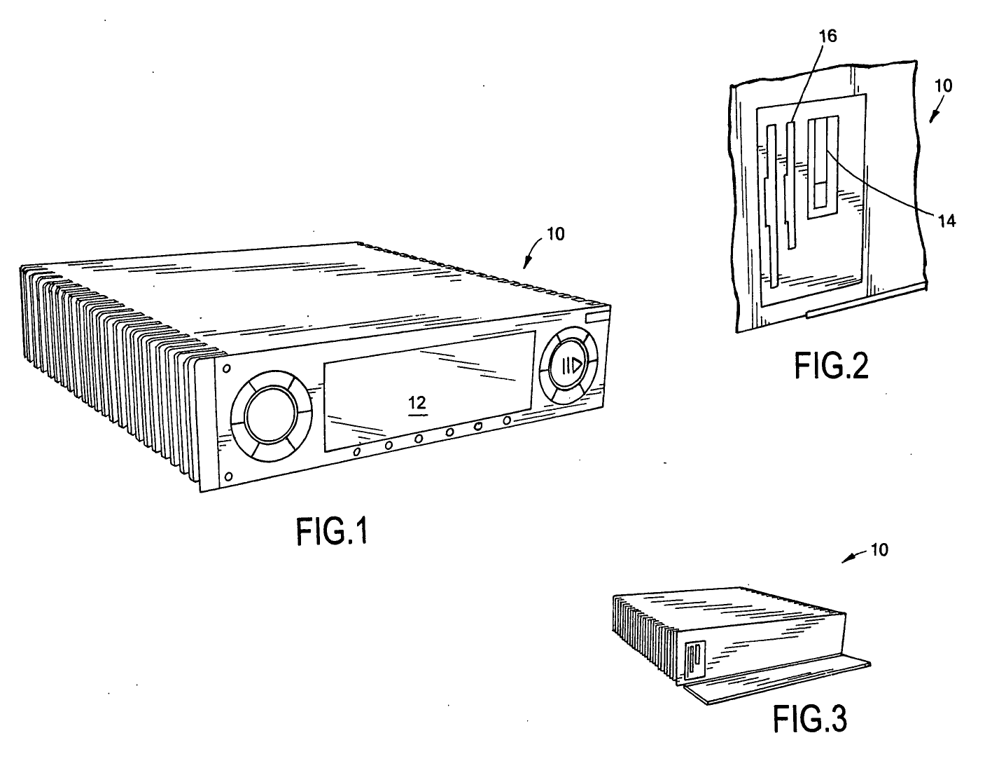

As illustrated in FIGS. 1-3, the present invention is an automobile MP3 system, indicated generally at 10, featuring extensive memory as well as downloading capability. Simply stated, the automobile MP3 system 10 of the present invention presents the next generation in automobile audio systems.

The automobile MP3 system 10 takes the latest car stereo system and incorporates a [digital] data storage device such as, for example, a hard drive [hard disk drive], SSD [Solid State Drive], or other data storage devices [fixed or removable] so that the user can store their digital music collection [Mp3 and the likes] on the automobile MP3 data storage device. Thus, instead of going through the cumbersome process of connecting an MP3 player to the car stereo, one can simply accesses the automobile MP3 system's own memory.

The automobile MP3 system 10 of the present invention has various models with features such as, for example, touch screen display 12, AM/FM radio, Satellite Radio, HD Radio, Internet radio, CD player, universal MP3 player capable of playing digital music MP3 and the likes, as well as ports for example such as USB ports 14, memory card ports 16, secure data card port and other auxiliary ports. With the automobile MP3 system 10 of the present invention, the user is able to store their music collection on the automobile MP3 system's Data Storage Device by downloading wired or wireless to or from a portable MP3 player, smart phone, computer, etc., via the Internet [Wi-Fi], Bluetooth, or other wireless methods.

The automobile MP3 system of the present invention is a compact unit similar in size and shape to standard car stereo, and designed for either permanent, in-dash mounting or as a removable unit for example with a slide-in mounting bracket. The programmable automobile MP3 system 10 also features a touch screen panel 12, LCD (Liquid Crystal Display) or other types, which may display multi-functions/controls for example (tuner, volume control, programmable playback, forward, rewind, mode selector, settings to select or repeat given songs and the likes). Some models the display panel can be customized, for example, to show graphics, pictures [a screen saver], display the time of day; and so forth, and may also feature voice recognition/voice command and similar type features. A power plug at the rear of the automobile MP3 system 10 provides connection to the vehicle's electrical system, and multiple jacks provide connections for the vehicle's speakers. In some models, for example, the passenger may be able to listen to something different from what is being played on the vehicle speakers, using headphones wired or wireless using Bluetooth or other technology, so the radio can be playing on the speakers and the passenger can be listening to the automobile MP3 system 10 on the headphones. The automobile MP3 system is also fully compatible with most wireless devices for example besides being able to download to or from cell/smart phones, MP3 players and the likes, users may also be able to play music from their cell phones, MP3 players wireless to automobile MP3 system 10 and out through the speakers using Bluetooth or other technology.

Innovative, versatile, state-of-the-art, compact, and sleek in styling device, the automobile MP3 system 10 of the present invention removes the “Digital Divide” between conventional car stereo systems and the increasingly popular, Internet-based world of downloaded digital audio files like MP3's. The automobile MP3 system 10 of the present invention is a versatile new auto stereo, universal MP3 and digital music player, radio and lots more, the automobile MP3 delivers digital-age, music to motorists, offering the utmost in personal choice and convenience.

Designed for installation in motor and other vehicles, the automobile MP3 system 10 presents users with several distinct benefits and advantages. Foremost, the automobile MP3 system 10 offers motorists a dramatic upgrade of automotive audio capability, i.e., a radio and CD player with a hard drive and programmable, downloadable memory equivalent to that of high-capacity personal devices such as the iPod. With the automobile MP3 system 10, the motorist no longer is limited to listening to whatever is playing on the radio nor to carting around a case of CDs. Instead, the automobile MP3 system 10 holds an entire personal library of songs in the MP3 or other format, the automobile MP3 system 10 of the present invention possesses full compatibility with the most popular formats and devices currently used for recording and playing music, and also possess exceptionally large storage capability for downloaded material. Downloading can be done directly from the Internet using Wi-Fi or other technology to automobile MP3 system 10 data storage device, because the automobile MP3 system 10 has Wi-Fi and Bluetooth. Downloading/uploading [file sharing] to or from may proceed directly from the Internet, music-sites and etc., without the aid of a computer to the automobile MP3 system 10 data storage device (song purchase may be required on some downloads). The automobile MP3 system 10 offers full compatibility with other MP3 playing devices and the likes, using USB, memory card port, Bluetooth or other technology. Music may also be streamed and played from a home computer, cell phone or the likes via the Internet and using a VPN [Virtual Private Network] or similar type network to play on Automobile MP3 system 10.

As technology advances some features of the automobile MP3 system 10 of the present invention can be added, removed, or modify to further improve and update/upkeep automobile MP3 system 10. It is also worth noting that features, color, materials, data storage device, and etc. can vary with each model and not all models may have a CD player, a touch display panel, some models may have buttons, touch buttons [non mechanical buttons, sliders, and wheels] or a combination. Some models may not have a built in [fixed] data storage device but may use a removable data storage device for example SD card, flash drive, and the likes.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. An automobile MP3 system for an automobile, the automobile MP3 system comprising:
a data storage device mounted within the automobile, the data storage device having memory for holding content and content downloading capability;
wherein the data storage device stores music and other content.

2. The automobile MP3 system of claim 1 wherein the data storage device is a digital data storage device.

3. The automobile MP3 system of claim 2 wherein the digital data storage device is a hard disk drive.

4. The automobile MP3 system of claim 1 wherein the data storage device is a solid state drive.

5. The automobile MP3 system of claim 1 wherein the data storage device is a fixed data storage device.

6. The automobile MP3 system of claim 1 wherein the data storage device is a removable data storage device.

7. The automobile MP3 system of claim 1 and further comprising:
a touch screen display for controlling operation of the data storage device.

8. The automobile MP3 system of claim 7 wherein the touch screen display controls tuner, volume control, programmable playback, forward, rewind, mode selector, settings to select or repeat given songs and the likes.

9. The automobile MP3 system of claim 7 wherein the display shows graphics, pictures, and the time of day.

10. The automobile MP3 system of claim 7 wherein the display features voice recognition/voice command and similar type features.

11. The automobile MP3 system of claim 1 and further comprising:
a radio selected from the group consisting of AM/FM radio, Satellite Radio, HD Radio, and Internet radio.

12. The automobile MP3 system of claim 1 and further comprising:
a CD player;

13. The automobile MP3 system of claim 1 and further comprising;
a universal MP3 player capable of playing digital music MP3 and the likes.

14. The automobile MP3 system of claim 13 and further comprising:
a USB port.

15. The automobile MP3 system of claim 13 and further comprising:
at least one memory card port, secure data card port, and other auxiliary ports.

16. The automobile MP3 system of claim 1 wherein content can be downloaded to the data storage device either wired or wireless to and from the data storage device via a device selected from the group consisting of a portable MP3 player, smart phone, and computer.

17. The automobile MP3 system of claim 16 wherein the download is accomplished via the Internet [Wi-Fi] or Bluetooth.

18. The automobile MP3 system of claim 1 wherein the data storage device is mounted in a dashboard of the automobile.

19. The automobile MP3 system of claim 18 wherein the in-dash mounting is either permanent or removable with a slide-in mounting bracket.

20. The automobile MP3 system of claim 1 wherein two users can access different content from the data storage device simultaneously.
